(19) United States
(12) Patent Application Publication
(10) Pub. No.: US 2008/0181793 A1
(43) Pub. Date: Jul. 31, 2008

(54) Electric Feedback/Yoke Angle Sensor For Position Feedback

(76) Inventors: Sanjay Ishvarlal Mistry, Johnston, IA (US); Christopher Paul Masini, Ames, IA (US); Steven Henry Gluck, Mount Horeb, WI (US)

Correspondence Address: DEERE & COMPANY, ONE JOHN DEERE PLACE, MOLINE, IL, 61265, US

(21) Appl. No.: 11/669,584

(22) Filed: Jan. 31, 2007

(51) Int. Cl. F04B 49/06; F15B 13/16

(52) U.S. Cl. 417/212; 91/361

(57) ABSTRACT

A variable displacement pump including a first sensor configured to measure a position of the variable displacement pump. The first sensor may be a rotary angle sensor that is mounted to the yoke shaft of the variable displacement pump. A controller is configured to receive position data from the first sensor and control a single or dual stage hydraulic control valve thereby adjusting the output of the first variable displacement pump.

### BACKGROUND

1. Field of the Invention

The present invention generally relates to a variable transmission with a variable displacement pump.

2. Description of Related Art

Over the years, variable transmissions have been introduced to control the torque output of engines. More recently, infinitely variable transmissions have been introduced to the market. Infinitely variable transmissions, typically, include a hydro mechanical module having an engine driven variable displacement pump. The variable displacement pump includes a yoke that pivots about a neutral position in order to accurately control the infinitely variable transmission. The position of the yoke must be controlled with respect to the desired position so as to allow the output speed to closely match the desired speed. Currently, some systems control the speed of a variable displacement pump based on the engine speed and the output speed, using mechanical feedback to adjust the pump speed. However, these systems are mechanically complicated and increase the size and weight of the overall system.

In view of the above, it is apparent that there exists a need for an improved variable transmission.

### SUMMARY

In satisfying the above need, as well as overcoming the enumerated drawbacks and other limitations of the related art, the present invention provides an improved variable transmission with a variable displacement pump. The variable displacement pump includes a first sensor configured to measure the position of the yoke of the pump. The first sensor may be a rotary angle sensor mounted to the yoke shaft. The rotary angle sensor corresponds to rotation of the yoke shaft and/or the rotation angle of the yoke. A controller is configured to receive position data from the first sensor and control a hydraulic valve, thereby adjusting the output of the first variable displacement pump. The hydraulic valve may be a single or dual stage hydraulic valve.

In another aspect of the present invention, the variable transmission includes two variable displacement pumps; the first pump having a first rotary angle sensor and a first hydraulic valve to provide a closed feedback loop and the second pump including a second rotary angle sensor in communication with the controller to adjust a second hydraulic valve thereby providing a second closed feedback loop. The controller is configured to calculate a hydraulic ratio between the speeds of the first and second variable displacement pumps based on the signals from the first and second sensors. Further, based on the hydraulic ratio, the controller controls the first and second displacement pumps.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a variable transmission according to one embodiment of the present invention; and

FIG. 2 is a sectional view of a pair of variable displacement pumps as used in accordance with the embodiment of FIG. 1.

### DETAILED DESCRIPTION

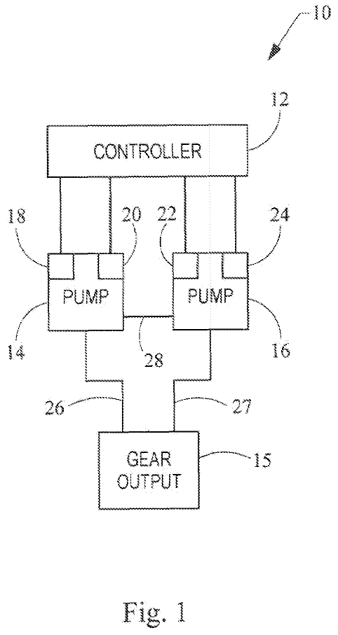

Referring now to FIG. 1, a system embodying the principles of the present invention is illustrated therein and designated at 10. The system 10 includes a controller 12, a first variable displacement pump 14, a second variable displacement pump 16, and an input/output gear unit 15. The controller 12 is in electrical communication with a first angle sensor 18 of the first displacement pump 14 and a second angle sensor 22 of the second variable displacement pump 16.

Based on the first and second angle sensors 18, 22, the controller 12 can calculate the hydraulic ratio of the first and second variable displacement pumps 14, 16 to optimize performance of the system. Accordingly, based on the input from the first and second angle sensors 18, 22, controller 12 manipulates two hydraulic valves. The first hydraulic valve 20 controls the output of the first variable displacement pump 14 and the second hydraulic valve 24 controls the output of the second variable displacement pump 16. The first and second variable displacement pumps 14, 16 are in hydraulic connection, as denoted by line 28. In addition, the first and second variable displacement pumps 14, 16 are in mechanical connection with the input/output gearing, as denote by lines 26, 27, combining to manipulate the input/output gear unit 15.

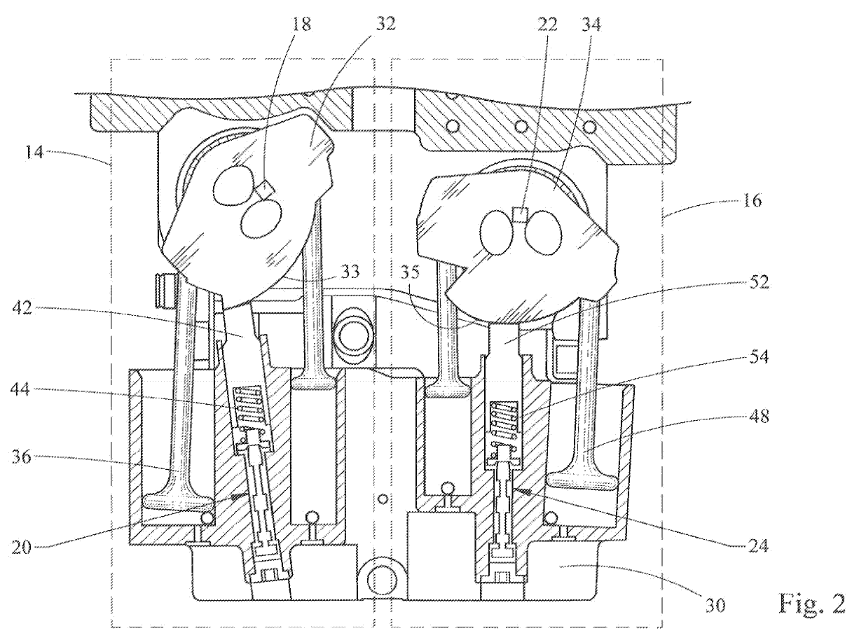

Referring now to FIG. 2, the first and second variable displacement pumps 14, 16 may each be of a known construction, such as a bent axis, 160 cc variable displacement pump configured for use in a tractor. As such, the first variable displacement pump 14 may be a clutched unit that is mechanically driven by either a carrier of a planetary gear when a first clutch is engaged, or a sun gear of the planetary gear when a second clutch is engaged. In addition, the second variable displacement pump 16 may comprise a ring unit that is mechanically driven by a ring gear, which is driven from the engine through a planetary gear set. The first and second variable displacement pumps 14, 16, are connected hydraulically through an iron manifold and with the manifold are contained within a support housing 30 that is mechanically isolated from the system transmission case.

The first and second variable displacement pumps 14, 16 are each generally controlled in a similar fashion. However, the first variable displacement pump 14, configured as a clutched unit, is mounted in a yoke 32 that pivots from a −45° to +45° angle. The second variable displacement pump 16, configured as a ring unit, is mounted in a yoke 34 that pivots from −15° to +45°. The first variable displacement pump 14 includes a hydraulic valve 20 and a servo piston 36, the former controlling the position of the latter, and the latter in turn, controlling the position of the first variable displacement pump 14. A mechanical linkage 42 provides feedback between the yoke 32 of the first variable displacement pump 14 and the hydraulic control valve 20. Similarly, a servo piston 48 of the second variable displacement pump 16 is controlled by the hydraulic valve 24 and the servo piston 48 controls the position of the second variable displacement pump 16. A mechanical linkage 52 provides feedback between the yoke 34 and the hydraulic valve 24 of the second variable displacement pump 16. The hydraulic valves 20, 24 have multiple ports and are configured to selectively connect a servo piston of the respective displacement pump to either a hydraulic reservoir to increase pressure in the servo piston or a hydraulic return tank to reduce pressure in the servo piston. By increasing or decreasing pressure in the servo piston, the controller 12 manipulates the yoke position of first and second variable displacement pumps 14, 16. As such, a balance of forces on the hydraulic valve 20 controls the angle of the first variable displacement pump 14 and a balance of forces on hydraulic valve 24 controls the angle of the second variable displacement pump 16. One of these forces is generated by hydraulic pressure supplied from an external electrohydraulic valve. The other of these forces is generated by a feedback spring 44, 54 that runs on cam profiles 33, 35 of the first and second variable displacement pump 14, 16 respectively. The first and second hydraulic valves 20, 24 position the yokes 32, 34 at a given angle based on the command given to the external electrohydraulic valve from the controller 12. The output speed of the output gear unit 15 is a function of the shaft speed, yoke angles, loading, and efficiencies of both the first and second variable displacement pumps.

One option is to replace existing mechanical feedback linkage with angle sensors. The first and second angle sensors 18, 22 may comprise rotary electric angle sensors that replace the mechanical feedback linkages 42, 52 and cam profiles 33, 35 of previous systems. The rotary angle sensors 18, 22 can be mounted on the yoke shaft of the first and second variable displacement pump 14, 16, with an interfacing mechanism. As such, the mechanical feedback of previous systems is replaced by electrical feedback. These electric angle sensors are more compact than the mechanical feedback system and provide electrical signals to the controller 12 that can be interpreted as a yoke angle position.

The mechanical feedback linkage may be replaced with a flow control valve and angle sensors. The flow control valve can be a single or dual stage proportional hydraulic valve to pressurize the servo pistons 36, 48 and control position of yokes 32, 34. The controller 12 uses the position of the rotary angle sensors 18, 22 to measure the position of the first and second variable displacement pump 14, 16. The controller 12 uses the position signals to calculate the hydraulic ratio between the first and second variable displacement pumps 14, 16 providing a closed loop feedback to optimize system performance. This design eliminates need for 20, 42, 44, 33, 24, 52, 54 and 35.

Accordingly, the embodiment described provides improved control using a closed loop electronic control algorithm and provide a real time hydraulic ratio information to optimize performance. In addition, the control system can be easily tuned using gain parameters stored in the electronic controller 12. Further, the need for lubrication of the mechanical feedback linkage is reduced due to the electronic feedback. The reduced friction minimizes hysteresis in the system and helps avoid wear caused by the mechanical feedback linkage. In addition, the direct measurement of the yoke angle and removal of the mechanical feedback system provide for improved control accuracy and remove significant constraints on the package size of the system.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A system for a variable transmission comprising:
a first variable displacement pump;
a first sensor attached to the variable displacement pump and configured to measure a yoke position of the variable displacement pump.

2. The system according to claim 1, wherein the sensor comprises an angle sensor.

3. The system according to claim 1, wherein the first variable displacement pump is a clutched unit.

4. The system according to claim 1, wherein the first variable displacement pump is a clutched unit.

5. The system according to claim 1, wherein the first variable displacement pump is a ring unit.

6. The system according to claim 1, further comprising a first hydraulic control valve in hydraulic communication with the first variable displacement pump.

7. The system according to claim 1, wherein the first hydraulic control valve comprises a single stage or dual stage proportional hydraulic control valve.

8. The system according to claim 1, wherein the first variable displacement pump comprises a bent axis displacement pump.

9. The system according to claim 8, further comprising a controller in electrical communication with the sensor, the controller being configured to use an electronic control algorithm to position the yoke of the variable displacement pump.

10. The system according to claim 1, further comprising a second variable displacement pump.

11. The system according to claim 10, further comprising a controller in electrical communication with the sensor to receive a sensor signal, the controller being configured to calculate a hydraulic ratio between the first and second variable displacement pump based on the sensor signal.

12. The system according to claim 11, wherein the first variable displacement pump is a clutched unit.

13. The system according to claim 12, wherein the second variable displacement pump is a ring unit.

14. The system according to claim 10, wherein the first and second variable displacement pumps are in hydraulic communication.

15. The system according to claim 10, further comprising a second sensor attached to the second variable displacement pump and configured to measure a yoke position of the second variable displacement pump.

16. The system according to claim 10, further comprising a controller in electrical communication with a first sensor to receive a first sensor signal, and the controller being in electrical communication with the second sensor to receive a second sensor signal, the controller being configured to calculate a hydraulic ratio between the first and second variable displacement pump based on the first and second sensor signal.

17. The system according to claim 10, further comprising a second hydraulic control valve in hydraulic communication with the second variable displacement pump.

18. The system according to claim 17, further comprising a controller in electrical communication with the first and second hydraulic control valve and configured to control the first and second hydraulic control valve based on a signal from the first and second sensor.
